(19) United States
(12) Patent Application Publication
(10) Pub. No.: US 2026/0247208 A1
(43) Pub. Date: Aug. 20, 2026

(54) MECHANISM FOR QUALITY OF SERVICE-RELATED CAPABILITY UPDATE IN WIRELESS COMMUNICATIONS

(71) Applicant: Intel Corporation, Santa Clara, CA (US)

(72) Inventors: Dibakar DAS, Hillsboro, OR (US); Danny BEN-ARI, Hasharon Hatichon (IL); Necati CANPOLAT, Beaverton, OR (US); Po-Kai HUANG, San Ramon, CA (US); Laurent CARIOU, Milizac (FR); Ganesh VENKATESAN, Hillsboro, OR (US)

(21) Appl. No.: 19/642,275

(22) Filed: Apr. 8, 2026

Related U.S. Application Data
(60) Provisional application No. 63/785,846, filed on Apr. 9, 2025.

(51) Int. Cl. H04W 28/02; H04W 8/22

(52) U.S. Cl. CPC H04W 28/0268; H04W 8/22

(57) ABSTRACT

This disclosure describes systems, methods, and devices related to enhanced quality of service signaling in wireless communications. A device may generate a capabilities element indicating support for end-to-end (E2E) quality of service (QoS) provisioning; transmit a management frame including the capabilities element; identify a stream classification service (SCS) request from a first station (STA) to establish an E2E QoS flow between the first STA and a second STA; identify traffic for the E2E QoS flow using a traffic classification (TCLAS) element of classifier type 0 included within the SCS request; identify QoS parameters in the SCS request as applying to an entire path between the first STA and the second STA rather than applying to a single medium access control (MAC) hop; and initiate an SCS setup with the second STA to complete the E2E QoS provisioning.

### CROSS-REFERENCE TO RELATED APPLICATION(S)

This application claims the benefit of U.S. Provisional Application No. 63/785,846, filed Apr. 9, 2025, the disclosure of which is incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment, in accordance with one or more example embodiments of the present disclosure.

FIG. 2A shows example extended reality (XR) traffic flows between two devices that are part of a same basic service set of an access point and that are routed by the access point in between the two devices, in accordance with one or more example embodiments of the present disclosure.

FIG. 2B shows example XR traffic flows between two devices and that are routed by two access points (APs) in the middle and that are part of a same extended service set using a wireless backhaul, in accordance with one or more example embodiments of the present disclosure.

FIG. 2C shows example XR traffic flows between two devices and that are routed by two APs in the middle and that are part of a same extended service set using an Ethernet backhaul, in accordance with one or more example embodiments of the present disclosure.

FIG. 3 shows an example traffic flow between stations (STAs) with an AP in the middle, in accordance with one or more example embodiments of the present disclosure.

FIG. 4 shows an example end-to-end (E2E) stream classification service (SCS) setup with validation of SCS stream set up by a first STA to a second STA via a first AP and a second AP where the second AP initiates the SCS stream between the second AP and the second STA, in accordance with one or more example embodiments of the present disclosure.

FIG. 5 shows an example E2E SCS setup with validation of SCS stream set up by a first STA to a second STA via a first AP and a second AP where the second AP initiates the SCS stream between the second AP and the second STA and the first AP validates the SCS stream, in accordance with one or more example embodiments of the present disclosure.

FIG. 6 shows an example E2E SCS setup with validation of SCS stream set up by a first STA to a second STA via a first AP and a second AP using Wi-Fi as a backhaul and where the first STA initiates the SCS Request with the first AP, the first AP establishes the SCS stream with the second AP, and the first AP requests the second AP to initiate the SCS stream between the second AP and the second STA, in accordance with one or more example embodiments of the present disclosure.

FIG. 7 shows an example E2E SCS setup with validation of SCS stream set up by a first STA to a second STA via a first AP and a second AP using Wi-Fi as a backhaul and where the first STA initiates the SCS Request with the first AP, the first AP establishes the SCS stream with the second AP, and the first AP requests the second AP to initiate the SCS stream between the second AP and the second STA and the first AP validates the SCS stream, in accordance with one or more example embodiments of the present disclosure.

FIG. 8 illustrates a flow diagram of a process for an illustrative enhanced capability update system, in accordance with one or more example embodiments of the present disclosure.

FIG. 9 illustrates a functional diagram of an exemplary communication station that may be suitable for use as a user device, in accordance with one or more example embodiments of the present disclosure.

FIG. 10 illustrates a block diagram of an example machine upon which any of one or more techniques (e.g., methods) may be performed, in accordance with one or more example embodiments of the present disclosure.

FIG. 11 is a block diagram of a radio architecture in accordance with some examples.

FIG. 12 illustrates an example front-end module circuitry for use in the radio architecture of FIG. 11, in accordance with one or more example embodiments of the present disclosure.

FIG. 13 illustrates an example radio IC circuitry for use in the radio architecture of FIG. 11, in accordance with one or more example embodiments of the present disclosure.

FIG. 14 illustrates an example baseband processing circuitry for use in the radio architecture of FIG. 11, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define Wi-Fi® (hereinafter referred to as Wi-Fi or WiFi) communications, including defining Quality of Service (QoS). Currently, QoS capabilities of station devices (STAs) and access point devices (APs) are exchanged during discovery/association and are assumed to stay static. However, a STA's ability to support features like Stream Classification Service (SCS) might be delayed by upper-layer middleware or proprietary agreements that are only finalized post-association. In addition, the existing SCS signaling only considers the “one-hop” delay from a STA to its associated AP. It does not account for traffic between two STAs in the same Basic Service Set (BSS) or across different BSSs within the same Extended Service Set (ESS).

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing features to further advance Wi-Fi technology.

SCS has been the main QoS signaling mechanism since the release of the 802.11be standard. Per the current 802.11 definition, a STA and its associated AP discover each other's SCS related capability during discovery and association. After association, STA sends an SCS Request to its AP to negotiate an SCS agreement.

In the WFA (Wi-Fi Aware) QCO (Quality and Connectivity Optimization) program, a group has defined a way for STA to report some of its QoS analytics statistics to a peer AP. During association and discovery, the STA may signal in the Wi-Fi Alliance Capabilities element its support for one of the three statistics attributes listed in the program: DAR Latency Statistics Reporting Support, DAR Control Plane Events Reporting Support, and DAR Control Plane Events Reporting Support.

Currently, capabilities of STA or AP are exchanged at the beginning of the association and they are assumed to stay static during the lifetime of the association. However, there may be some cases where the capabilities may be modified due to some upper layer or other conditions, which the STA or AP may indicate updates to the capabilities as described below.

It is possible that a STA's capability to send SCS Request is influenced by some entity above the MAC-SAP. If such entity or middleware is not ready to construct SCS when the STA gets associated, then the STA may not indicate its SCS capabilities during association. As such we need a way for STA to indicate its SCS capability post-association without data interruption caused by disassociation and re-association.

It is possible that a STA is not willing to share its capability to support a QCO attribute until some proprietary agreement is established between the STA and its associated AP post-association. In such cases, the STA would need to signal different QCO capability post-association.

Example embodiments of the present disclosure relate to systems, methods, and devices for mechanism for QoS related capability update.

In one or more embodiments, the following are some of the proposed solutions being advanced in this disclosure:
The STA sends a new Mgt frame with updated capability information related to different QoS parameters.
On receipt of this frame indicating STA's updated capabilities, the AP uses the new capability of the STA to perform SCS, QoS Analytics and other procedures with that STA.

The present disclosure enhances the QoS signaling in Wi-Fi networks, including for 802.1bn, addressing the static nature of device capabilities and the lack of true end-to-end QoS for multi-hop traffic.

In one or more embodiments, the present disclosure provides a mechanism for a Station (STA) or Access Point (AP) to update its QoS-related capabilities after the initial association without requiring a disruptive disassociation/re-association process. A new management frame is introduced to carry updated capability information post-association. New action frames are proposed, including a vendor-specific action frame (e.g., DAR request response) and a dedicated DAR Capability update frame. The enhancements herein may include restricting updates to only specific QoS parameters like SCS traffic description or SCS support, for example, to maintain network stability. In addition, a new element may include both IEEE-defined and WFA-specific QoS parameters as sub-elements.

In one or more embodiments, the existing SCS mechanism may be enhanced to support latency and traffic requirement for flows passing through one or more APs. This is critical for use cases such as Extended Reality (XR), for example. An AP may signal its capabilities to support E2E QoS in beacons, probe responses, and association responses. Fields such as MSDU lifetime, delay bound, and service start time may be reinterpreted to apply to an entire path (e.g., source STA to destination STA) rather than just a single MAC (medium access control) hop. A TCLAS (traffic classification) Type 0 element may be used to identify source and destination MAC addresses for end-to-end flow identification. To prevent security risks where an AP forces a STA to configure traffic patterns, a Token/Nonce/Tag system is introduced. A STA can use a shared unique identity (DevIK) to validate that an SCS stream setup by an AP was indeed requested by the peer STA.

In one or more embodiments, a system may comprise one or more components, which may include one or more of: apparatus, device, station (STA), access point (AP), and/or other network elements. At its most basic configuration, the system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

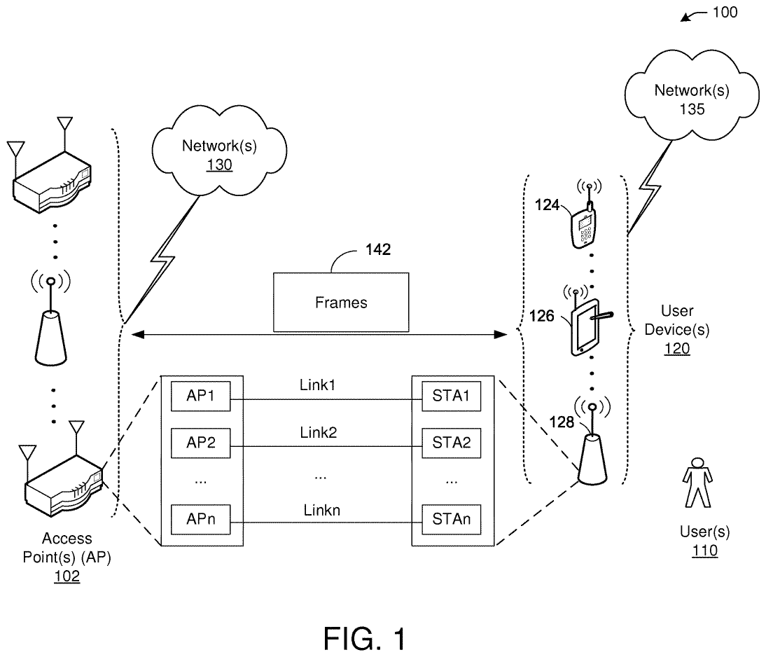

FIG. 1 is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

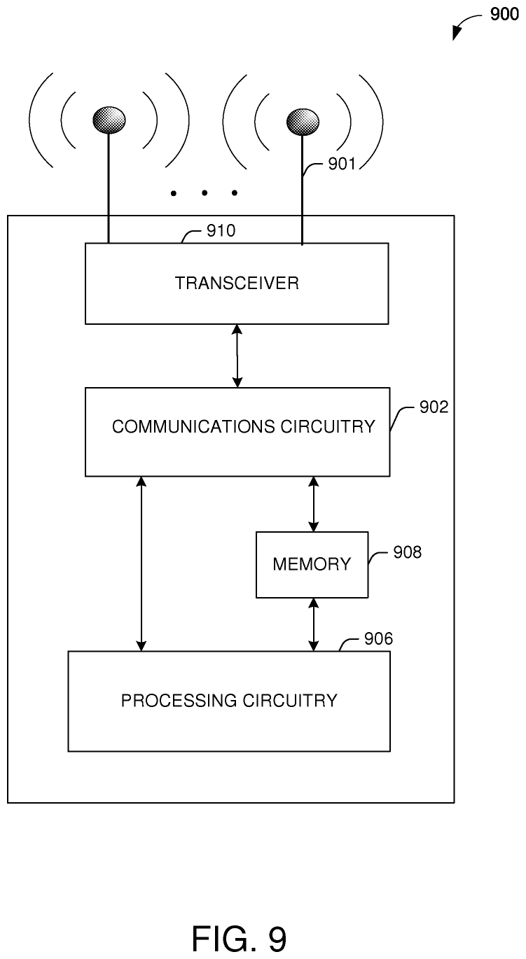

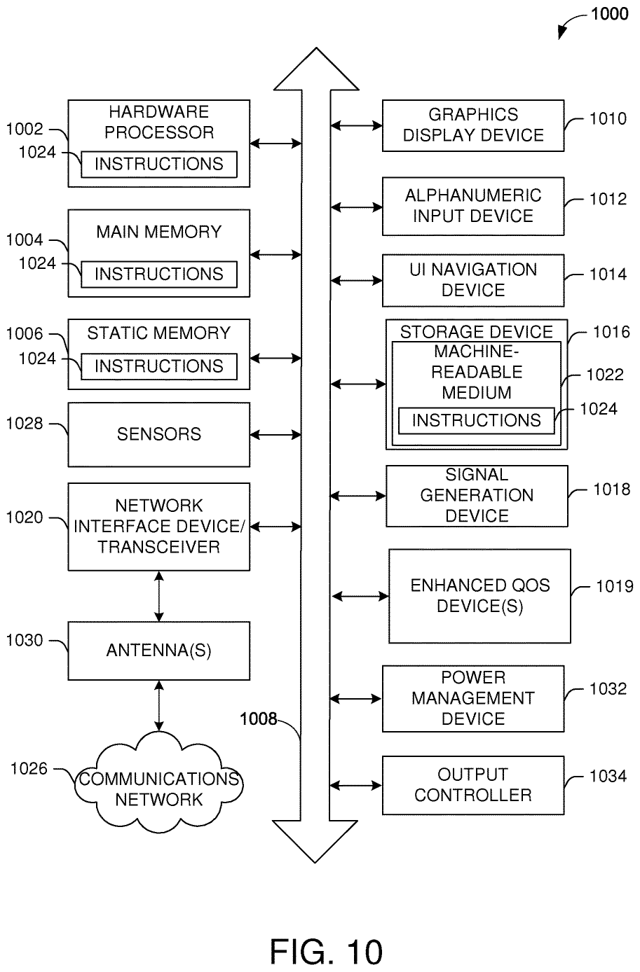

In some embodiments, the user devices 120 and the AP 102 may include one or more computer systems similar to that of the functional diagram of FIG. 9 and/or the example machine/system of FIG. 10.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may exchange frames 142 with one or more user devices 120. The frames 142 may include a new management frame (e.g., to carry updated capability information without requiring disassociation and re-association), vendor-specific action frames (e.g., DAR request/response), dedicated action frames (e.g., DAR capability update frame), SCS request and response frames, discovery and association frames (e.g., beacons, probe responses, association responses, etc.), and other frames described herein.

The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

In one embodiment the information is carried in a Vendor-specific Action frame (e.g., DAR Request/Response frames) or another Action frame (e.g., “DAR Capability update frame”).

In one embodiment the information related to IEEE-defined QoS support is carried in a new element. For example, the element can signal SCS Traffic Description Support (which is signaled in baseline inside EHT MAC Capabilities element) and/or SCS support (which is signaled in baseline inside the Extended Capabilities element). This element could be a vendor-specific (WFA) element.

In one embodiment the information related to WFA parameters could be signaled in a new or existing vendor-specific element (e.g., the Wi-Fi Alliance Capabilities element). If an existing element is used, then only certain parameters (e.g., the ones directly related to the QCO program) may be allowed to be set differently than how it was signaled during association.

In one embodiment even for the non-WFA parameters the information could be signaled in the same elements that are used during association (e.g., Extended Capabilities element for SCS etc.). However, the 802.11 specification (“spec”) can restrict so that only those QoS related parameters are allowed to change from association.

In one embodiment a single new element can contain both the WFA and non-WFA QoS related parameters that may change during the association as different sub-elements.

In one embodiment this can also be done using the same capability update feature as planned for some wifi-8 features such as DPS.

The above embodiments provide STAs participating in sharing AP's BSS more protection while also preserving C-TDMA gains for STAs participating in the C-TDMA sequence of shared AP.

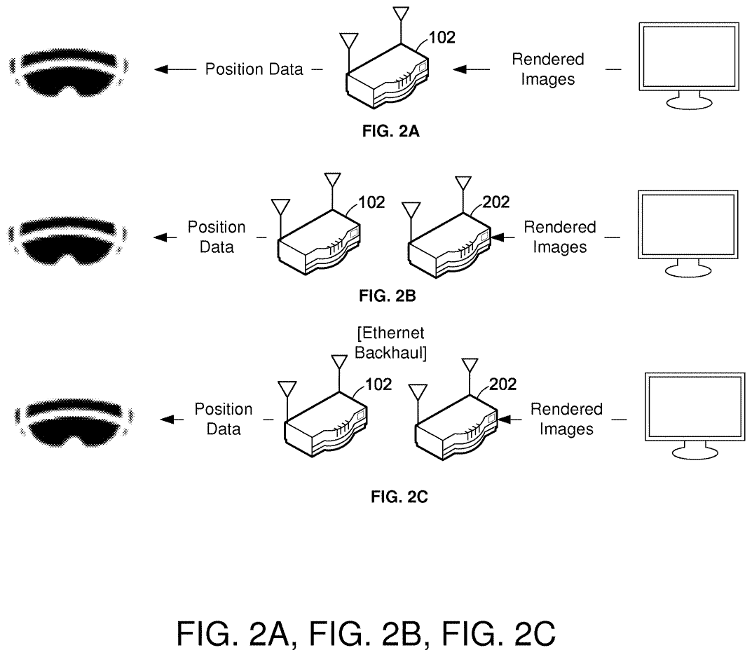

FIG. 2A shows example XR traffic flows between two devices that are part of a same basic service set of an access point and that are routed by the access point in between the two devices, in accordance with one or more example embodiments of the present disclosure.

Referring to FIG. 2A, a high-compute device (e.g., a laptop or desktop) may collect positional data from a VR headset (HMD) and render images to be displayed to the HMD. The traffic from the laptop/desktop to HMD may be heavy and periodic (e.g., 60 frames per second at 100 Mbps) while the traffic from the HMD to laptop may be lighter with a different periodicity (e.g., a 1400B packet every 4 ms). For both flows, there may be an E2E latency bound that needs to be satisfied (e.g., the IMU data must be delivered to the HMD by 10 ms with 99% probability, etc.). However, current QoS provisioning in Wi-Fi, such as SCS with a QoS Characteristics element, only considers the one-hop delay from an STA to its associated AP (e.g., AP 102).

FIG. 2B shows example XR traffic flows between two devices and that are routed by two APs (e.g., AP 102 and AP 202) in the middle and that are part of a same extended service set using a wireless backhaul, in accordance with one or more example embodiments of the present disclosure.

FIG. 2C shows example XR traffic flows between two devices and that are routed by two APs (e.g., AP 102 and AP 202) in the middle and that are part of a same extended service set using an Ethernet backhaul, in accordance with one or more example embodiments of the present disclosure.

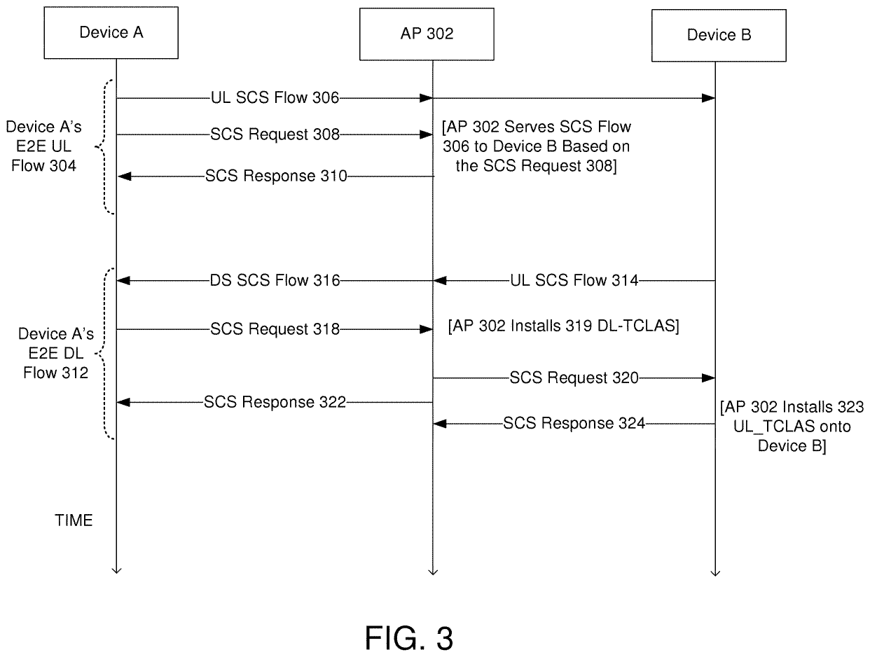

FIG. 3 shows an example traffic flow between STAs with an AP in the middle, in accordance with one or more example embodiments of the present disclosure.

Referring to FIG. 3, during Device A's E2E UL flow 304, Device A may send a UL SCS flow 306 to the AP 302, and may send an SCS request 308 (e.g., signaling UL_QoS, _e2e and DeviceB_id) to the AP 32. The AP 302 may serve the SCS flow 306 to Device B based on the information in the SCS request 308, and may respond with an SCS response 310 (e.g., indicating a status). During Device A's E2E DL flow 312, Device B may send its UL SCS flow 314 to the AP 302, the AP 302 may send a DL SCS flow 316 to Device A. Device A may send an SCS Request 318 to the AP 302 (e.g., singling DL_QoS_e2e, DL_TCLAS, UL_TCLAS, and DeviceB_id). The AP 302 may install 319 the DL_TCLAS on itself and may send an SCS Request 320 (signaling UL_TCLAS) to Device B. The AP 302 may send an SCS Response 322 to Device A (e.g., signaling the status), and may install 323 UL_TCLAS onto Device B. Then, Device B may send an SCS response 324 (e.g., signaling status) to the AP 302.

One proposal for a flow between the STAs via an AP in the middle is that one STA may send an SCS Request that specifies that the flow is for the other STA and also specifies a latency bound for the flow. Another proposal is for a flow from the other STA to the first STA in which an AP may send an SCS request to the other STA for setting up SCS on behalf of the other STA in the UL direction after receiving an SCS request from the first STA. However, these proposals do not make use of existing signaling schemes such as TCLAS to identify the DL traffic. Also, these proposals do not cover the use case in which the two STAs are not in the same BSS, but rather are in the same ESS (e.g., with the multiple APs in between the STAs). In addition, requiring the other STA to configure its UL traffic pattern based on the first STA's request may raise security challenges.

Other proposals include the SCS request that carries a QoS Characteristics element modified to carry a QoS IE on behalf of the other STA, and that TCLAS may be used. Another proposal provides for using SCAS with TCLAS to signal E2E requirements, but is limited to signaling in the QoS Characteristics element to inform the AP to schedule the other SCS stream with the same requirements. There is another proposal to add signaling in the QoS Characteristics element to interpret the latency bound field as an end-to-end latency bound and add an end-destination MAC address. However, what is missing from these proposals is (1) a detailed signaling for how QoS Characteristics may be used with an existing signaling for end-destination identification (e.g., TCLAS) along with how other parameters in the QoS Characteristics element need to be reinterpreted for scenarios covering both BSS and ESS use cases, and (2) a way for the second STA to validate an SCS Request set up by an AP for serving a flow to/from a first STA.

In some embodiments, an AP signals in a Capabilities element (e.g., WiFi-8 capabilities or Extended Capabilities or Vendor Specific/TBD Capabilities element defined by WFA), transmitted in Beacon, Probe Response and Association Response frames, its capability of supporting end-to-end QoS by (a) using TCLAS of Classifier Type 0 to identify the source and end-destinations and (b) using the QoS Characteristics element sent in same SCS Request to identify the traffic parameters. A STA associated to this AP would know from this capability indication whether it can set up E2E QoS provisioning through this AP. The AP may signal separate capabilities for establishing E2E QoS between STAs in same BSS and between STAs across different BSS in same ESS (including BSSs that are collocated) for example, by two bits.

In some embodiments, the following parameters in current QoS Characteristics element may be re-interpreted to signal that they apply on an E2E basis (i.e., from the source STA to destination STA) rather than between MAC-SAP to MAC-SAP in one hop: MSDU Lifetime, Delay Bound, Service Start Time.

In some embodiments, an AP may initiate SCS setup with another STA by sending an SCS Request. Such an SCS Request could be sent for E2E QoS provisioning but could also be for policy signaling. When it is for signaling E2E QoS provisioning a TCLAS element of Classifier Type 0, is included that has the STA as the SA (for UL) or DA (for DL).

In some embodiments, a token is used to validate the two one hop QoS flows making up an overall E2E QoS flow.

In some embodiments where an E2E QoS flow is established between STA1 and STA2 associated to AP1 and AP2 respectively (where AP1 and AP2 may be a same AP or two different APs in same ESS), STA1 sends an SCS Request to AP1 containing a TCLAS and a token. If AP2 sets up an SCS stream with STA2, then AP2 includes the above token within the SCS Request sent to STA2. On receipt of the token, STA2 validates that the SCS stream is indeed initiated from STA1. If STA2 sends an SCS Request to set up the SCS stream between AP2 and STA2, then it includes the same token or some other parameter that would allow AP2 to validate against the token AP1 received from STA1. We assume the tokens are known across the ESS among the APs.

In some embodiments, the token usage could be similar to the Pairing identity verification process in Wi-Fi Direct that is STA1 and STA2 have unique DevIK values that's known to each other. It could be provisioned securely above the MAC layer. The DevIK value is fed to a cryptographic function along with a Nonce to generate a Tag. The (Nonce, Tag) values would be shared from STA1 to AP1 and in turn propagated from AP2 to STA2. When STA2 receives the token=(Nonce, Tag) it generates its own Tag from the known DevIK and the received Nonce value which it then compares against the received Tag. If there is a match, the SCS stream set up from AP2 to STA2 is validated to be indeed setup by STA1.

In some embodiments, if the DevIK values are known at intermediate APs, then the E2E SCS stream setup could be directly validated by the intermediate APs by generating a Tag value from the known DevIK values and then comparing against the received Tag value.

In some embodiments, the AP1 sends an SCS Response with status code Success to STA1 only after AP2 and STA2 sets up the SCS stream.

In some embodiments, the AP1 sends an SCS Response with status code =Success to STA1 prior to AP2 and STA2 setting up the SCS stream. If the SCS stream setup between AP2 and STA2 doesn't succeed, then AP1 sends an SCS Response with status code signaling failure to setup the other end of the SCS flow.

In some embodiments, the token value could be an SCSID.

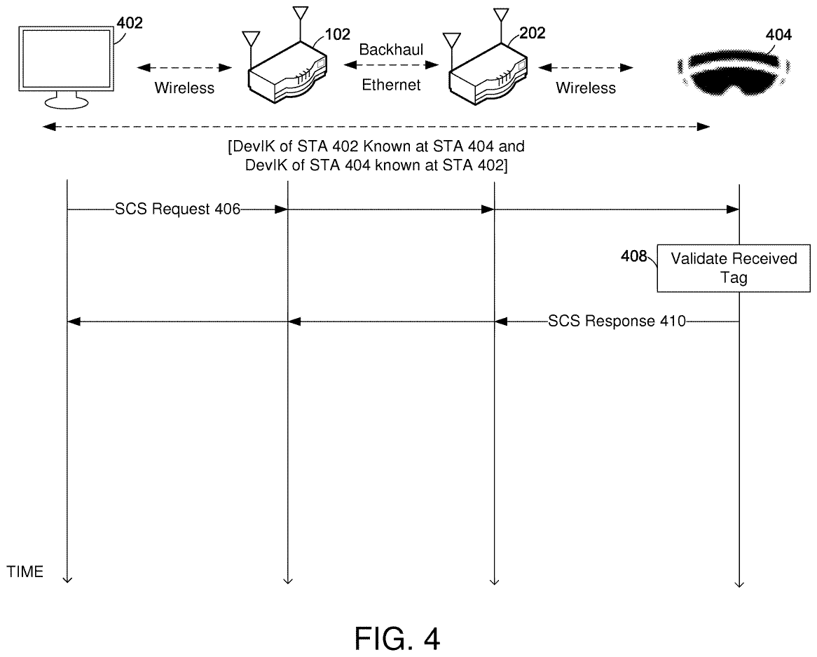

FIG. 4 shows an example E2E SCS setup with validation of SCS stream set up by a first STA to a second STA via a first AP and a second AP where the second AP initiates the SCS stream between the second AP and the second STA, in accordance with one or more example embodiments of the present disclosure.

Referring to FIG. 4, a DevIK of a STA 402 may be known by a STA 404, and a DevIK of the STA 404 may be known by the STA 402. The STA 402 may send an SCS Request 406 (e.g., including QoS Char(UL), TCLAS(DA=STA2, SA=STA1), (Tag, Nonce)) to the AP 102, which may provide the SCS Request 406 to the AP 202, which may provide the SCS Request 406 (e.g., with the QoS Char(UL) changed to QoS Char(DL) for downlink) to the STA 404. The STA 404 may validate 408 the received tag with a tag generated from the received Nonce and the known DevIK of the STA 402. Then the STA 404 may send an SCS Response 410 (e.g., signaling success) to the AP 202, which may provide the SCS Response 410 to the AP 102, which may provide the SCS Response 410 to the STA 402.

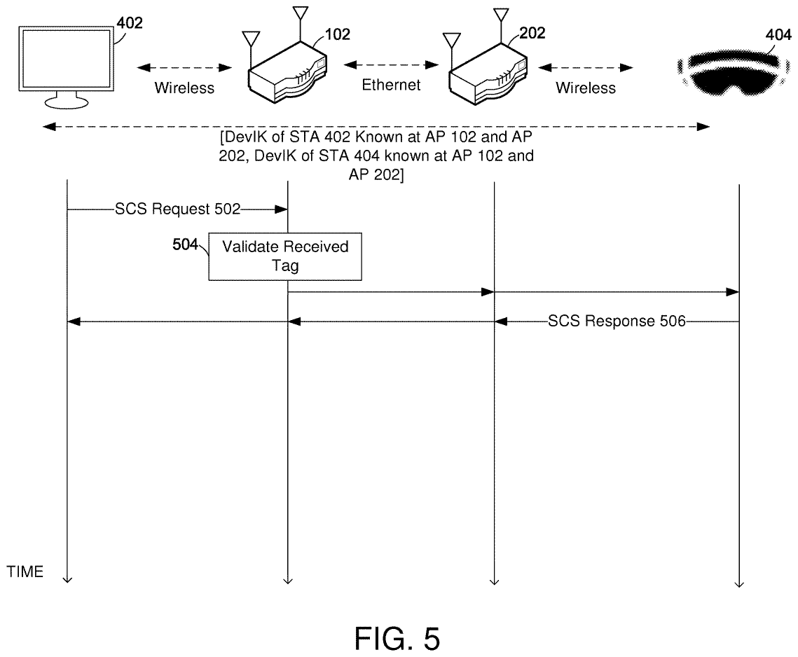

FIG. 5 shows an example E2E SCS setup with validation of SCS stream set up by a first STA to a second STA via a first AP and a second AP where the second AP initiates the SCS stream between the second AP and the second STA and the first AP validates the SCS stream, in accordance with one or more example embodiments of the present disclosure.

Referring to FIG. 5, a DevIK of the STA 402 may be known by the AP 102 and the AP 202, and a DevIK of the STA 404 may be known by the AP 102 and the AP 202. The STA 402 may send an SCS Request 502 (e.g., including QoS Char(UL), TCLAS(DA=STA2, SA=STA1), (Tag, Nonce)) to the AP 102. The AP 102 may validate 504 the received tag with a tag generated from the received Nonce and the known DevIK of the STA 402. The AP 102 may provide the SCS Request 502 to the AP 202, which may provide the SCS Request 502 (e.g., with the QoS Char(UL) changed to QoS Char(DL) for downlink) to the STA 404. The STA may send an SCS Response 506 (e.g., signaling success) to the AP 202, which may provide the SCS Response 506 to the AP 102, which may provide the SCS Response 506 to the STA 402.

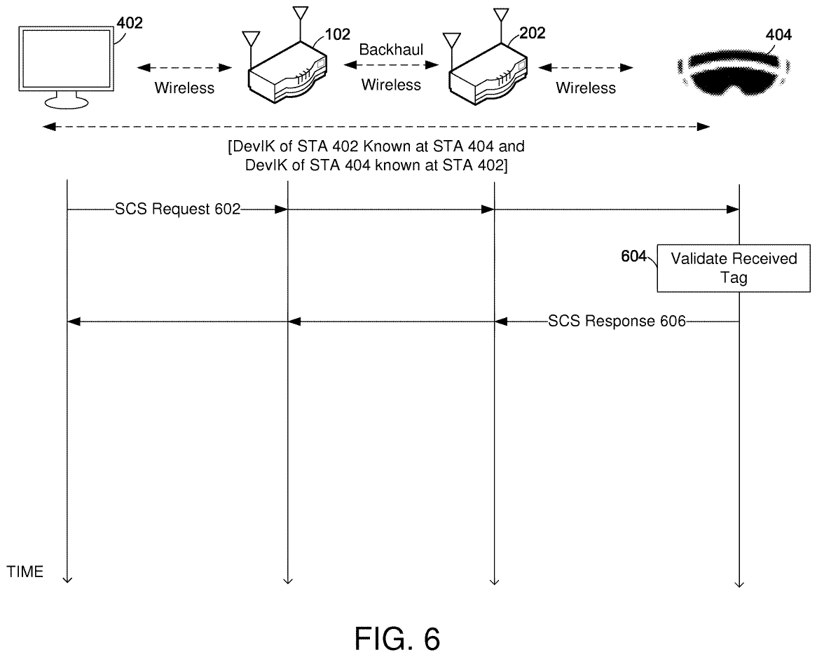

FIG. 6 shows an example E2E SCS setup with validation of SCS stream set up by a first STA to a second STA via a first AP and a second AP using Wi-Fi as a backhaul and where the first STA initiates the SCS Request with the first AP, the first AP establishes the SCS stream with the second AP, and the first AP requests the second AP to initiate the SCS stream between the second AP and the second STA, in accordance with one or more example embodiments of the present disclosure.

Referring to FIG. 6, a DevIK of the STA 402 may be known by the STA 402, and a DevIK of the STA 404 may be known by the STA 402. The STA 402 may send an SCS Request 602 (e.g., including QoS Char(UL), TCLAS(DA=STA2, SA=STA1), (Tag, Nonce)) to the AP 102. The AP 102 may provide the SCS Request 602 to the AP 202, which may provide the SCS Request 602 (e.g., with the QoS Char(UL) changed to QoS Char(DL) for downlink) to the STA 404. The STA 404 may validate 604 the received tag with a tag generated from the received Nonce and the known DevIK of the STA 402. The STA may send an SCS Response 606 (e.g., signaling success) to the AP 202, which may provide the SCS Response 606 to the AP 102, which may provide the SCS Response 606 to the STA 402.

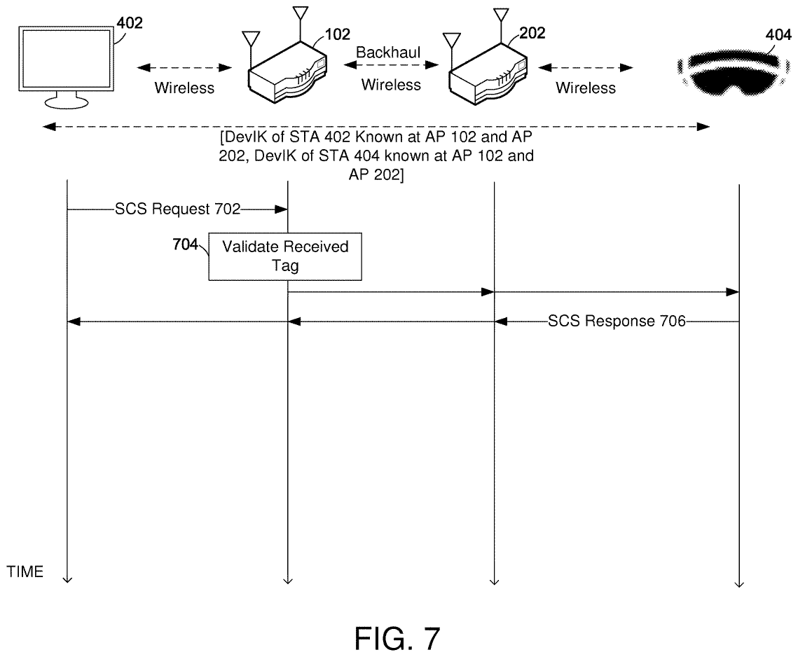

FIG. 7 shows an example E2E SCS setup with validation of SCS stream set up by a first STA to a second STA via a first AP and a second AP using Wi-Fi as a backhaul and where the first STA initiates the SCS Request with the first AP, the first AP establishes the SCS stream with the second AP, and the first AP requests the second AP to initiate the SCS stream between the second AP and the second STA and the first AP validates the SCS stream, in accordance with one or more example embodiments of the present disclosure.

Referring to FIG. 7, a DevIK of the STA 402 may be known by the AP 102 and the AP 202, and a DevIK of the STA 404 may be known by the AP 102 and the AP 202. The STA 402 may send an SCS Request 702 (e.g., including QoS Char(UL), TCLAS(DA=STA2, SA=STA1), (Tag, Nonce)) to the AP 102. The AP 102 may validate 704 the received tag with a tag generated from the received Nonce and the known DevIK of the STA 402. The AP 102 may provide the SCS Request 702 to the AP 202, which may provide the SCS Request 702 (e.g., with the QoS Char(UL) changed to QoS Char(DL) for downlink) to the STA 404. The STA may send an SCS Response 706 (e.g., signaling success) to the AP 202, which may provide the SCS Response 706 to the AP 102, which may provide the SCS Response 706 to the STA 402.

Referring to FIGS. 4-7, the STA 402 and the STA 404 may have unique DevIK values known to each other and that may be provisioned securely above the MAC layer. The DevIK value is fed to a cryptographic function along with a Nonce to generate a Tag. The (Nonce, Tag) values would be shared from STA 402 to AP 102 and in turn propagated from AP 202 to STA 404. When STA 404 receives the token=(Nonce, Tag) it generates its own Tag from the known DevIK and the received Nonce value which it then compares against the received Tag. If there is a match, the SCS stream set up from AP 202 to STA 404 is validated to be indeed setup by STA 402.

In one embodiment if the DevIK values are known at intermediate APs, then the E2E SCS stream setup could be directly validated by the intermediate APs by generating a Tag value from the known DevIK values and then comparing against the received Tag value. FIGS. 5 and 7 show an example of this process.

In one embodiment the AP 102 sends an SCS Response with status code Success to STA 402 only after AP 202 and STA 404 sets up the SCS stream.

In one embodiment the AP 102 sends an SCS Response with status code =Success to STA 402 prior to AP 202 and STA 404 setting up the SCS stream. If the SCS stream setup between AP 202 and STA 404 doesn't succeed, then AP 102 sends an SCS Response with status code signaling failure to setup the other end of the SCS flow.

In one embodiment the token value could be an SCSID.

It is understood that the above descriptions are for the purposes of illustration and are not meant to be limiting.

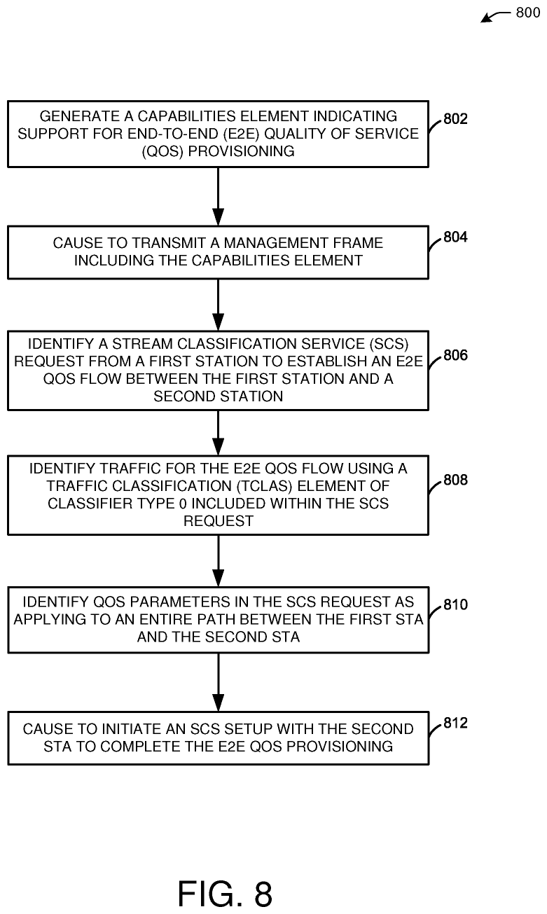

FIG. 8 illustrates a flow diagram of illustrative process 800 for an enhanced capability update system, in accordance with one or more example embodiments of the present disclosure.

At block 802, a device (or system, e.g., the AP 102 of FIG. 1, the enhanced QoS devices 1019 of FIG. 1) may generate a capabilities element indicating support for end-to-end (E2E) quality of service (QoS) provisioning. In some embodiments, separate capabilities may be signaled for establishing E2E QoS between STAs in a same BSS and between STAs across different BSSs in a same ESS, for example, by using two bits.

At block 804, the device may cause to transmit a management frame including the capabilities element. This management frame may be transmitted by processing circuitry 906 via communications circuitry 902 and transceiver 910 using one or more antennas 901. Examples of such management frames include a beacon, a probe response, and an association response frame.

At block 806, the device may identify a stream classification service (SCS) request from a first station (STA), such as user device 120 or STA 402, to establish an E2E QoS flow between the first STA and a second STA, such as STA 404. This request may be received over a wireless communication network 130 or 135.

At block 808, the device may identify traffic for the E2E QoS flow using a traffic classification (TCLAS) element of classifier type 0 included within the SCS request. TCLAS element of classifier type 0 may be used to identify source and end-destinations. For example, TCLAS element may have a STA as a source address (SA) for an uplink (UL) flow or a destination address (DA) for a downlink (DL) flow.

At block 810, the device may identify QoS parameters in the SCS request as applying to an entire path between the first STA and the second STA rather than applying to a single medium access control (MAC) hop. These re-interpreted QoS parameters may include at least one of: MAC service data unit (MSDU) Lifetime, Delay Bound, or Service Start Time.

At block 812, the device may cause to initiate an SCS setup with the second STA to complete the E2E QoS provisioning. In various implementations, system may include a token in the SCS setup with second STA to allow second STA to validate that E2E QoS flow was initiated by first STA. This security token may consist of a Nonce and a Tag generated from a unique device identity (DevIK) known to first STA and second STA.

It is understood that the above descriptions are for the purposes of illustration and are not meant to be limiting.

FIG. 9 shows a functional diagram of an exemplary communication station 900, in accordance with one or more example embodiments of the present disclosure. In one embodiment, FIG. 9 illustrates a functional block diagram of a communication station that may be suitable for use as an AP 102 (FIG. 1) or a user device 120 (FIG. 1) in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer (PHY) communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in the above figures, diagrams, and flows.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device.

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number o components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The machine 1000 may additionally include a storage device (i.e., drive unit) 1016, a signal generation device 1018 (e.g., a speaker), an enhanced QoS device 1019, a network interface device/transceiver 1020 coupled to antenna(s) 1030, and one or more sensors 1028, such as a global positioning system (GPS) sensor, a compass, an accelerometer, or other sensor. The machine 1000 may include an output controller 1034, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1002 for generation and processing of the baseband signals and for controlling operations of the main memory 1004, the storage device 1016, and/or the enhanced QoS device 1019. The baseband processor may be provided on a single radio card, a single chip, or an integrated circuit (IC).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The enhanced QoS device 1019 may carry out or perform any of the operations and processes (e.g., process 800) described and shown above.

It is understood that the above are only a subset of what the enhanced QoS device 1019 may be configured to perform and that other functions included throughout this disclosure may also be performed by the enhanced QoS device 1019.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

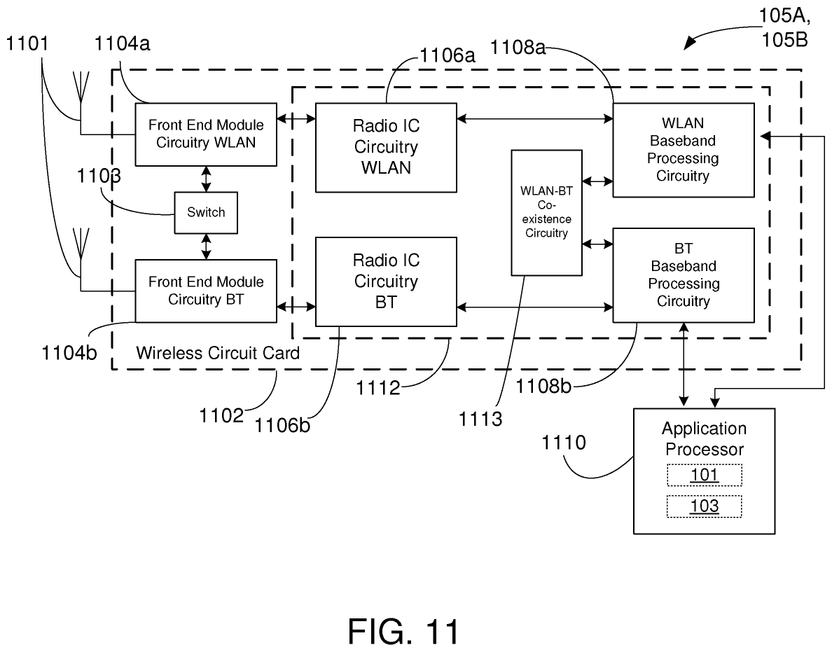

FIG. 11 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1104a-b, radio IC circuitry 1106a-b and baseband processing circuitry 1108a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1104a-b may include a WLAN or Wi-Fi FEM circuitry 1104a and a Bluetooth (BT) FEM circuitry 1104b. The WLAN FEM circuitry 1104a may include a receive signal path comprising circuitry configured to operate on WLAN RF signals received from one or more antennas 1101, to amplify the received signals and to provide the amplified versions of the received signals to the WLAN radio IC circuitry 1106a for further processing. The BT FEM circuitry 1104b may include a receive signal path which may include circuitry configured to operate on BT RF signals received from one or more antennas 1101, to amplify the received signals and to provide the amplified versions of the received signals to the BT radio IC circuitry 1106b for further processing. FEM circuitry 1104a may also include a transmit signal path which may include circuitry configured to amplify WLAN signals provided by the radio IC circuitry 1106a for wireless transmission by one or more of the antennas 1101. In addition, FEM circuitry 1104b may also include a transmit signal path which may include circuitry configured to amplify BT signals provided by the radio IC circuitry 1106b for wireless transmission by the one or more antennas. In the embodiment of FIG. 11, although FEM 1104a and FEM 1104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1106a-b as shown may include WLAN radio IC circuitry 1106a and BT radio IC circuitry 1106b. The WLAN radio IC circuitry 1106a may include a receive signal path which may include circuitry to down-convert WLAN RF signals received from the FEM circuitry 1104a and provide baseband signals to WLAN baseband processing circuitry 1108a. BT radio IC circuitry 1106b may in turn include a receive signal path which may include circuitry to down-convert BT RF signals received from the FEM circuitry 1104b and provide baseband signals to BT baseband processing circuitry 1108b. WLAN radio IC circuitry 1106a may also include a transmit signal path which may include circuitry to up-convert WLAN baseband signals provided by the WLAN baseband processing circuitry 1108a and provide WLAN RF output signals to the FEM circuitry 1104a for subsequent wireless transmission by the one or more antennas 1101. BT radio IC circuitry 1106b may also include a transmit signal path which may include circuitry to up-convert BT baseband signals provided by the BT baseband processing circuitry 1108b and provide BT RF output signals to the FEM circuitry 1104b for subsequent wireless transmission by the one or more antennas 1101. In the embodiment of FIG. 11, although radio IC circuitries 1106a and 1106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 1108a-b may include a WLAN baseband processing circuitry 1108a and a BT baseband processing circuitry 1108b. The WLAN baseband processing circuitry 1108a may include a memory, such as, for example, a set of RAM arrays in a Fast Fourier Transform or Inverse Fast Fourier Transform block (not shown) of the WLAN baseband processing circuitry 1108a. Each of the WLAN baseband circuitry 1108a and the BT baseband circuitry 1108b may further include one or more processors and control logic to process the signals received from the corresponding WLAN or BT receive signal path of the radio IC circuitry 1106a-b, and to also generate corresponding WLAN or BT baseband signals for the transmit signal path of the radio IC circuitry 1106a-b. Each of the baseband processing circuitries 1108a and 1108b may further include physical layer (PHY) and medium access control layer (MAC) circuitry, and may further interface with a device for generation and processing of the baseband signals and for controlling operations of the radio IC circuitry 1106a-b.

Referring still to FIG. 11, according to the shown embodiment, WLAN-BT coexistence circuitry 1113 may include logic providing an interface between the WLAN baseband circuitry 1108a and the BT baseband circuitry 1108b to enable use cases requiring WLAN and BT coexistence. In addition, a switch 1103 may be provided between the WLAN FEM circuitry 1104a and the BT FEM circuitry 1104b to allow switching between the WLAN and BT radios according to application needs. In addition, although the antennas 1101 are depicted as being respectively connected to the WLAN FEM circuitry 1104a and the BT FEM circuitry 1104b, embodiments include within their scope the sharing of one or more antennas as between the WLAN and BT FEMs, or the provision of more than one antenna connected to each of FEM 1104a or 1104b.

In some embodiments, the front-end module circuitry 1104a-b, the radio IC circuitry 1106a-b, and baseband processing circuitry 1108a-b may be provided on a single radio card, such as wireless radio card 1102. In some other embodiments, the one or more antennas 1101, the FEM circuitry 1104a-b and the radio IC circuitry 1106a-b may be provided on a single radio card. In some other embodiments, the radio IC circuitry 1106a-b and the baseband processing circuitry 1108a-b may be provided on a single chip or integrated circuit (IC), such as IC 1112.

In some embodiments, the wireless radio card 1102 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1108b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

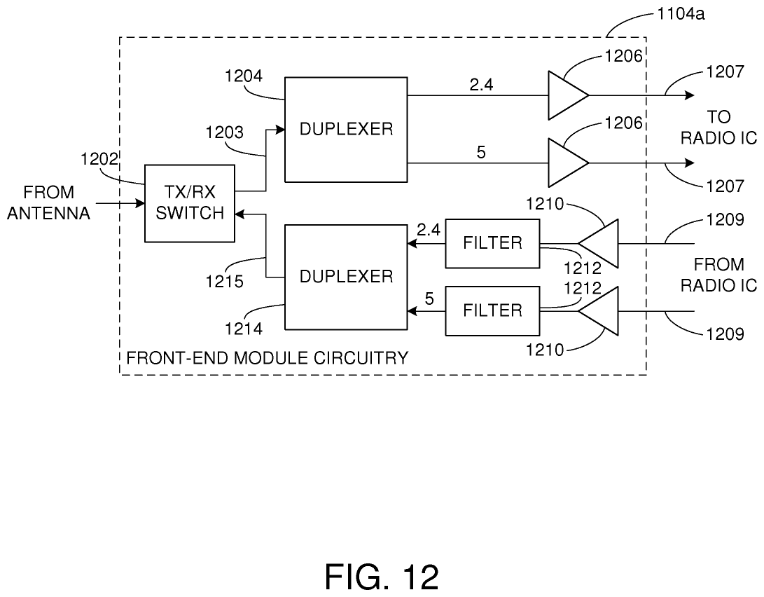

FIG. 12 illustrates WLAN FEM circuitry 1104a in accordance with some embodiments. Although the example of FIG. 12 is described in conjunction with the WLAN FEM circuitry 1104a, the example of FIG. 12 may be described in conjunction with the example BT FEM circuitry 1104b (FIG. 11), although other circuitry configurations may also be suitable.

In some embodiments, the FEM circuitry 1104a may include a TX/RX switch 1202 to switch between transmit mode and receive mode operation. The FEM circuitry 1104a may include a receive signal path and a transmit signal path. The receive signal path of the FEM circuitry 1104a may include a low-noise amplifier (LNA) 1206 to amplify received RF signals 1203 and provide the amplified received RF signals 1207 as an output (e.g., to the radio IC circuitry 1106a-b (FIG. 11)). The transmit signal path of the circuitry 1104a may include a power amplifier (PA) to amplify input RF signals 1209 (e.g., provided by the radio IC circuitry 1106a-b), and one or more filters 1212, such as band-pass filters (BPFs), low-pass filters (LPFs) or other types of filters, to generate RF signals 1215 for subsequent transmission (e.g., by one or more of the antennas 1101 (FIG. 11)) via an example duplexer 1214.

In some dual-mode embodiments for Wi-Fi communication, the FEM circuitry 1104a may be configured to operate in either the 2.4 GHz frequency spectrum or the 5 GHz frequency spectrum. In these embodiments, the receive signal path of the FEM circuitry 1104a may include a receive signal path duplexer 1204 to separate the signals from each spectrum as well as provide a separate LNA 1206 for each spectrum as shown. In these embodiments, the transmit signal path of the FEM circuitry 1104a may also include a power amplifier 1210 and a filter 1212, such as a BPF, an LPF or another type of filter for each frequency spectrum and a transmit signal path duplexer 1204 to provide the signals of one of the different spectrums onto a single transmit path for subsequent transmission by the one or more of the antennas 1101 (FIG. 11). In some embodiments, BT communications may utilize the 2.4 GHz signal paths and may utilize the same FEM circuitry 1104a as the one used for WLAN communications.

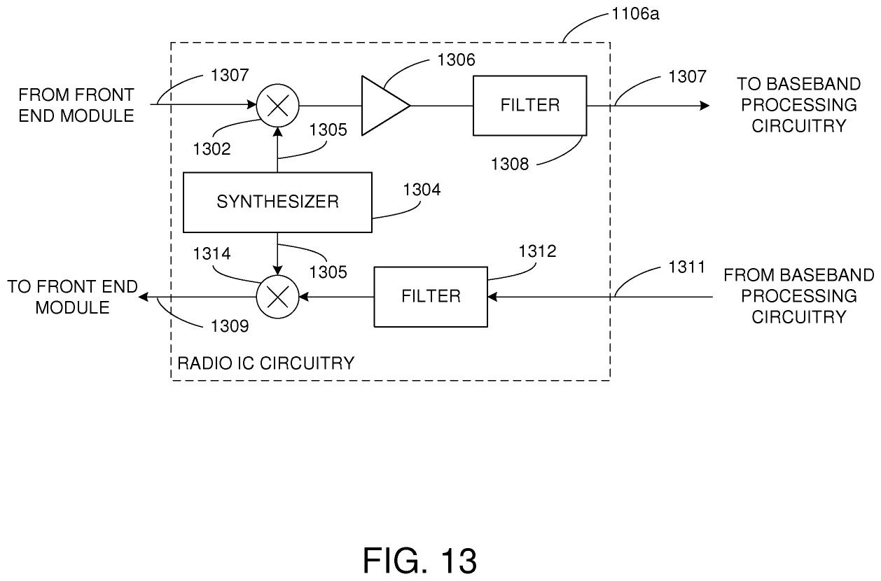

FIG. 13 illustrates radio IC circuitry 1106a in accordance with some embodiments. The radio IC circuitry 1106a is one example of circuitry that may be suitable for use as the WLAN or BT radio IC circuitry 1106a/1106b (FIG. 11), although other circuitry configurations may also be suitable. Alternatively, the example of FIG. 13 may be described in conjunction with the example BT radio IC circuitry 1106b.

In some embodiments, the radio IC circuitry 1106a may include a receive signal path and a transmit signal path. The receive signal path of the radio IC circuitry 1106a may include at least mixer circuitry 1302, such as, for example, down-conversion mixer circuitry, amplifier circuitry 1306 and filter circuitry 1308. The transmit signal path of the radio IC circuitry 1106a may include at least filter circuitry 1312 and mixer circuitry 1314, such as, for example, up-conversion mixer circuitry. Radio IC circuitry 1106a may also include synthesizer circuitry 1304 for synthesizing a frequency 1305 for use by the mixer circuitry 1302 and the mixer circuitry 1314. The mixer circuitry 1302 and/or 1314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 13 illustrates only a simplified version of a radio IC circuitry, and may include, although not shown, embodiments where each of the depicted circuitries may include more than one component. For instance, mixer circuitry 1314 may each include one or more mixers, and filter circuitries 1308 and/or 1312 may each include one or more filters, such as one or more BPFs and/or LPFs according to application needs. For example, when mixer circuitries are of the direct-conversion type, they may each include two or more mixers.

In some embodiments, mixer circuitry 1302 may be configured to down-convert RF signals 1207 received from the FEM circuitry 1104a-b (FIG. 11) based on the synthesized frequency 1305 provided by synthesizer circuitry 1304. The amplifier circuitry 1306 may be configured to amplify the down-converted signals and the filter circuitry 1308 may include an LPF configured to remove unwanted signals from the down-converted signals to generate output baseband signals 1307. Output baseband signals 1307 may be provided to the baseband processing circuitry 1108a-b (FIG. 11) for further processing. In some embodiments, the output baseband signals 1307 may be zero-frequency baseband signals, although this is not a requirement. In some embodiments, mixer circuitry 1302 may comprise passive mixers, although the scope of the embodiments is not limited in this respect.

In some embodiments, the mixer circuitry 1314 may be configured to up-convert input baseband signals 1311 based on the synthesized frequency 1305 provided by the synthesizer circuitry 1304 to generate RF output signals 1209 for the FEM circuitry 1104a-b. The baseband signals 1311 may be provided by the baseband processing circuitry 1108a-b and may be filtered by filter circuitry 1312. The filter circuitry 1312 may include an LPF or a BPF, although the scope of the embodiments is not limited in this respect.

In some embodiments, the mixer circuitry 1302 and the mixer circuitry 1314 may each include two or more mixers and may be arranged for quadrature down-conversion and/or up-conversion respectively with the help of synthesizer 1304. In some embodiments, the mixer circuitry 1302 and the mixer circuitry 1314 may each include two or more mixers each configured for image rejection (e.g., Hartley image rejection). In some embodiments, the mixer circuitry 1302 and the mixer circuitry 1314 may be arranged for direct down-conversion and/or direct up-conversion, respectively. In some embodiments, the mixer circuitry 1302 and the mixer circuitry 1314 may be configured for super-heterodyne operation, although this is not a requirement.

Mixer circuitry 1302 may comprise, according to one embodiment: quadrature passive mixers (e.g., for the in-phase (I) and quadrature phase (Q) paths). In such an embodiment, RF input signal 1207 from FIG. 13 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1305 of synthesizer 1304 (FIG. 13). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 1207 (FIG. 12) may comprise a balanced signal, although the scope of the embodiments is not limited in this respect. The I and Q baseband output signals may be provided to low-noise amplifier, such as amplifier circuitry 1306 (FIG. 13) or to filter circuitry 1308 (FIG. 13).

In some embodiments, the output baseband signals 1307 and the input baseband signals 1311 may be analog baseband signals, although the scope of the embodiments is not limited in this respect. In some alternate embodiments, the output baseband signals 1307 and the input baseband signals 1311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1304 may be a fractional-N synthesizer or a fractional N/N+1 synthesizer, although the scope of the embodiments is not limited in this respect as other types of frequency synthesizers may be suitable. For example, synthesizer circuitry 1304 may be a delta-sigma synthesizer, a frequency multiplier, or a synthesizer comprising a phase-locked loop with a frequency divider. According to some embodiments, the synthesizer circuitry 1304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1304 may be provided by a voltage controlled oscillator (VCO), although that is not a requirement. A divider control input may further be provided by either the baseband processing circuitry 1108a-b (FIG. 11) depending on the desired output frequency 1305. In some embodiments, a divider control input (e.g., N) may be determined from a look-up table (e.g., within a Wi-Fi card) based on a channel number and a channel center frequency as determined or indicated by the example application processor 1110. The application processor 1110 may include, or otherwise be connected to, one of the example secure signal converter 101 or the example received signal converter 103 (e.g., depending on which device the example radio architecture is implemented in).

In some embodiments, synthesizer circuitry 1304 may be configured to generate a carrier frequency as the output frequency 1305, while in other embodiments, the output frequency 1305 may be a fraction of the carrier frequency (e.g., one-half the carrier frequency, one-third the carrier frequency). In some embodiments, the output frequency 1305 may be a LO frequency (fLO).

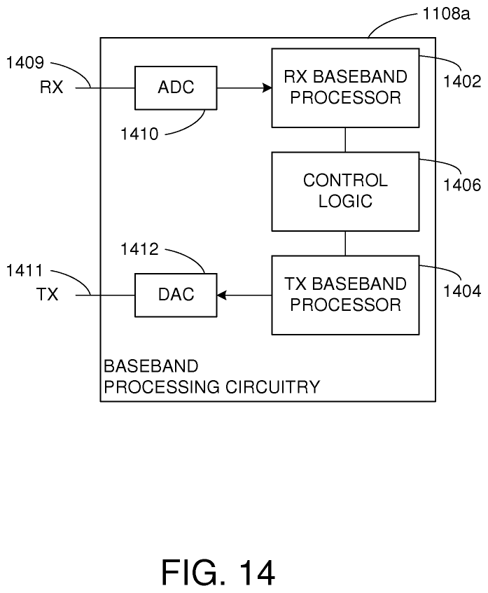

FIG. 14 illustrates a functional block diagram of baseband processing circuitry 1108a in accordance with some embodiments. The baseband processing circuitry 1108a is one example of circuitry that may be suitable for use as the baseband processing circuitry 1108a (FIG. 11), although other circuitry configurations may also be suitable. Alternatively, the example of FIG. 13 may be used to implement the example BT baseband processing circuitry 1108b of FIG. 11.

The baseband processing circuitry 1108a may include a receive baseband processor (RX BBP) 1402 for processing receive baseband signals 1309 provided by the radio IC circuitry 1106a-b (FIG. 11) and a transmit baseband processor (TX BBP) 1404 for generating transmit baseband signals 1311 for the radio IC circuitry 1106a-b. The baseband processing circuitry 1108a may also include control logic 1406 for coordinating the operations of the baseband processing circuitry 1108a.

In some embodiments (e.g., when analog baseband signals are exchanged between the baseband processing circuitry 1108a-b and the radio IC circuitry 1106a-b), the baseband processing circuitry 1108a may include ADC 1410 to convert analog baseband signals 1409 received from the radio IC circuitry 1106a-b to digital baseband signals for processing by the RX BBP 1402. In these embodiments, the baseband processing circuitry 1108a may also include DAC 1412 to convert digital baseband signals from the TX BBP 1404 to analog baseband signals 1411.

In some embodiments that communicate OFDM signals or OFDMA signals, such as through baseband processor 1108a, the transmit baseband processor 1404 may be configured to generate OFDM or OFDMA signals as appropriate for transmission by performing an inverse fast Fourier transform (IFFT). The receive baseband processor 1402 may be configured to process received OFDM signals or OFDMA signals by performing an FFT. In some embodiments, the receive baseband processor 1402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 11, in some embodiments, the antennas 1101 (FIG. 11) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1101 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device including processing circuitry coupled to storage, the processing circuitry configured to: generate a capabilities element indicating support for end-to-end (E2E) quality of service (QoS) provisioning; cause to transmit a management frame comprising the capabilities element; identify a stream classification service (SCS) request from a first station (STA) to establish an E2E QoS flow between the first STA and a second STA; identify traffic for the E2E QoS flow using a traffic classification (TCLAS) element of classifier type 0 included within the SCS request; identify QoS parameters in the SCS request as applying to an entire path between the first STA and the second STA rather than applying to a single medium access control (MAC) hop; and cause to initiate an SCS setup with the second STA to complete the E2E QoS provisioning.

Example 2 may include the device of example 1 and/or any other example herein, wherein the processing circuitry is further configured to include a token in the SCS setup with the second STA to allow the second STA to validate that the E2E QoS flow was initiated by the first STA.

Example 3 may include the device of example 1 and/or any other example herein, wherein the QoS parameters identified as applying to the entire path include at least one of: MAC service data unit (MSDU) Lifetime, Delay Bound, or Service Start Time.

Example 4 may include the device of example 1 and/or any other example herein, wherein the processing circuitry is further configured to identify a second management frame including updated capability information related to QoS parameters from the first STA after an initial association, and analyze the updated capability information to determine new capabilities for the first STA without disassociation.

Example 5 may include the device of example 1 and/or any other example herein, wherein the first STA is associated with the device and the second STA is associated with a different access point within a same Extended Service Set (ESS).

Example 6 may include the device of example 1 and/or any other example herein, wherein the SCS setup with the second STA includes a security token consisting of a Nonce and a Tag generated from a unique device identity (DevIK) known to the first STA and the second STA.

Example 7 may include the device of example 1 and/or any other example herein, wherein the processing circuitry is further configured to validate the E2E SCS stream by generating a local Tag from a known DevIK value and comparing it against a received Tag value.

Example 8 may include the device of example 1 and/or any other example herein, further including a transceiver configured to transmit and receive wireless signals including the management frame and the SCS request.

Example 9 may include the device of example 8 and/or any other example herein, further comprising an antenna coupled to the transceiver to cause to send the management frame.

Example 10 may include a non-transitory computer-readable medium storing computer-executable instructions which when executed by one or more processors result in performing operations comprising to: generate a capabilities element indicating support for end-to-end (E2E) quality of service (QoS) provisioning; cause to transmit a management frame comprising the capabilities element; identify a stream classification service (SCS) request from a first station (STA) to establish an E2E QoS flow between the first STA and a second STA; identify traffic for the E2E QoS flow using a traffic classification (TCLAS) element of classifier type 0 included within the SCS request; identify QoS parameters in the SCS request as applying to an entire path between the first STA and the second STA rather than applying to a single medium access control (MAC) hop; and cause to initiate an SCS setup with the second STA to complete the E2E QoS provisioning.

Example 11 may include the non-transitory computer-readable medium of example 10 and/or any other example herein, wherein the operations further include to include a token in the SCS setup with the second STA to allow the second STA to validate that the E2E QoS flow was initiated by the first STA.

Example 12 may include the non-transitory computer-readable medium of example 10 and/or any other example herein, wherein the QoS parameters identified as applying to the entire path include at least one of: MAC service data unit (MSDU) Lifetime, Delay Bound, or Service Start Time.

Example 13 may include the non-transitory computer-readable medium of example 10 and/or any other example herein, wherein the operations further include to identify a second management frame including updated capability information related to QoS parameters from the first STA after an initial association, and analyze the updated capability information to determine new capabilities for the first STA without disassociation.

Example 14 may include the non-transitory computer-readable medium of example 10 and/or any other example herein, wherein the first STA is associated with the device and the second STA is associated with a different access point within a same Extended Service Set (ESS).

Example 15 may include a method including: generating, by processing circuitry of an access point (AP), a capabilities element indicating support for end-to-end (E2E) quality of service (QoS) provisioning; causing to transmit, by the processing circuitry, a management frame comprising the capabilities element; identifying, by the processing circuitry, a stream classification service (SCS) request from a first station (STA) to establish an E2E QoS flow between the first STA and a second STA; identifying, by the processing circuitry, traffic for the E2E QoS flow using a traffic classification (TCLAS) element of classifier type 0 included within the SCS request; identifying, by the processing circuitry, QoS parameters in the SCS request as applying to an entire path between the first STA and the second STA rather than applying to a single medium access control (MAC) hop; and causing to initiate, by the processing circuitry, an SCS setup with the second STA to complete the E2E QoS provisioning.

Example 16 may include the method of example 15 and/or any other example herein, further including a token in the SCS setup with the second STA to allow the second STA to validate that the E2E QoS flow was initiated by the first STA.

Example 17 may include the method of example 15 and/or any other example herein, wherein the QoS parameters identified as applying to the entire path include at least one of: MAC service data unit (MSDU) Lifetime, Delay Bound, or Service Start Time.

Example 18 may include the method of example 15 and/or any other example herein, further including identifying a second management frame comprising updated capability information related to QoS parameters from the first STA after an initial association, and analyzing the updated capability information to determine new capabilities for the first STA without disassociation.

Example 19 may include the method of example 15 and/or any other example herein, wherein the first STA is associated with the device and the second STA is associated with a different access point within a same Extended Service Set (ESS).

Example 20 may include the method of example 15 and/or any other example herein, wherein the SCS setup with the second STA includes a security token consisting of a Nonce and a Tag generated from a unique device identity (DevIK) known to the first STA and the second STA.

Example 21 may include an apparatus including means for performing any of the steps of examples 1-20.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
generate a capabilities element indicating support for end-to-end (E2E) quality of service (QoS) provisioning;
cause to transmit a management frame comprising the capabilities element;
identify a stream classification service (SCS) request from a first station (STA) to establish an E2E QoS flow between the first STA and a second STA;
identify traffic for the E2E QoS flow using a traffic classification (TCLAS) element of classifier type 0 included within the SCS request;
identify QoS parameters in the SCS request as applying to an entire path between the first STA and the second STA rather than applying to a single medium access control (MAC) hop; and
cause to initiate an SCS setup with the second STA to complete the E2E QoS provisioning.

2. The device of claim 1, wherein the processing circuitry is further configured to include a token in the SCS setup with the second STA to allow the second STA to validate that the E2E QoS flow was initiated by the first STA.

3. The device of claim 1, wherein the QoS parameters identified as applying to the entire path include at least one of: MAC service data unit (MSDU) Lifetime, Delay Bound, or Service Start Time.

4. The device of claim 1, wherein the processing circuitry is further configured to identify a second management frame comprising updated capability information related to QoS parameters from the first STA after an initial association, and analyze the updated capability information to determine new capabilities for the first STA without disassociation.

5. The device of claim 1, wherein the first STA is associated with the device and the second STA is associated with a different access point within a same Extended Service Set (ESS).

6. The device of claim 1, wherein the SCS setup with the second STA includes a security token consisting of a Nonce and a Tag generated from a unique device identity (DevIK) known to the first STA and the second STA.

7. The device of claim 1, wherein the processing circuitry is further configured to validate the E2E SCS stream by generating a local Tag from a known DevIK value and comparing it against a received Tag value.

8. The device of claim 1, further comprising a transceiver configured to transmit and receive wireless signals comprising the management frame and the SCS request.

9. The device of claim 8, further comprising an antenna coupled to the transceiver to cause to send the management frame.

10. A non-transitory computer-readable medium storing computer-executable instructions which when executed by one or more processors result in performing operations comprising to:
generate a capabilities element indicating support for end-to-end (E2E) quality of service (QoS) provisioning;
cause to transmit a management frame comprising the capabilities element;
identify a stream classification service (SCS) request from a first station (STA) to establish an E2E QoS flow between the first STA and a second STA;
identify traffic for the E2E QoS flow using a traffic classification (TCLAS) element of classifier type 0 included within the SCS request;
identify QoS parameters in the SCS request as applying to an entire path between the first STA and the second STA rather than applying to a single medium access control (MAC) hop; and
cause to initiate an SCS setup with the second STA to complete the E2E QoS provisioning.

11. The non-transitory computer-readable medium of claim 10, wherein the operations further comprise to include a token in the SCS setup with the second STA to allow the second STA to validate that the E2E QoS flow was initiated by the first STA.

12. The non-transitory computer-readable medium of claim 10, wherein the QoS parameters identified as applying to the entire path include at least one of: MAC service data unit (MSDU) Lifetime, Delay Bound, or Service Start Time.

13. The non-transitory computer-readable medium of claim 10, wherein the operations further comprise to identify a second management frame comprising updated capability information related to QoS parameters from the first STA after an initial association, and analyze the updated capability information to determine new capabilities for the first STA without disassociation.

14. The non-transitory computer-readable medium of claim 10, wherein the first STA is associated with the device and the second STA is associated with a different access point within a same Extended Service Set (ESS).

15. A method comprising:
generating, by processing circuitry of an access point (AP), a capabilities element indicating support for end-to-end (E2E) quality of service (QoS) provisioning;
causing to transmit, by the processing circuitry, a management frame comprising the capabilities element;
identifying, by the processing circuitry, a stream classification service (SCS) request from a first station (STA) to establish an E2E QoS flow between the first STA and a second STA;
identifying, by the processing circuitry, traffic for the E2E QoS flow using a traffic classification (TCLAS) element of classifier type 0 included within the SCS request;
identifying, by the processing circuitry, QoS parameters in the SCS request as applying to an entire path between the first STA and the second STA rather than applying to a single medium access control (MAC) hop; and
causing to initiate, by the processing circuitry, an SCS setup with the second STA to complete the E2E QoS provisioning.

16. The method of claim 15, further comprising a token in the SCS setup with the second STA to allow the second STA to validate that the E2E QoS flow was initiated by the first STA.

17. The method of claim 15, wherein the QoS parameters identified as applying to the entire path include at least one of: MAC service data unit (MSDU) Lifetime, Delay Bound, or Service Start Time.

18. The method of claim 15, further comprising identifying a second management frame comprising updated capability information related to QoS parameters from the first STA after an initial association, and analyzing the updated capability information to determine new capabilities for the first STA without disassociation.

19. The method of claim 15, wherein the first STA is associated with the device and the second STA is associated with a different access point within a same Extended Service Set (ESS).

20. The method of claim 15, wherein the SCS setup with the second STA includes a security token consisting of a Nonce and a Tag generated from a unique device identity (DevIK) known to the first STA and the second STA.
